(19) United States
(12) Patent Application Publication
(10) Pub. No.: US 2009/0278912 A1
(43) Pub. Date: Nov. 12, 2009

(54) MEDICAL AUDIO/VIDEO COMMUNICATIONS SYSTEM

(75) Inventor: Ronald Carter, Matthews, NC (US)

Correspondence Address: TILLMAN WRIGHT, PLLC, PO BOX 49309, CHARLOTTE, NC, 28277-0076, US

(73) Assignee: REVOLUTIONARY CONCEPTS, INC., Matthews, NC (US)

(21) Appl. No.: 12/464,080

(22) Filed: May 11, 2009

Related U.S. Application Data
(60) Provisional application No. 61/052,243, filed on May 11, 2008.

(51) Int. Cl. H04N 7/14

(52) U.S. Cl. 348/14.02; 348/E07.077

(57) ABSTRACT

Two-way audiovideo communications are provided between a patient located in a room and a remotely located caregiver using a wireless handheld device, whereby the remotely located caregiver may remain accessible by patients and may remotely look-in on patients. A method includes: transmitting, to the wireless handheld device used by the caregiver, audiovideo of the patient recorded using a camera located in the room; transmitting, to the wireless handheld device used by the caregiver, audiovideo of the patient recorded using a microphone located in the room; and transmitting, to a speaker located in the room for playing to the patient, audio of the caregiver recorded using the wireless handheld device. The transmitting includes wireless communications between the camera and microphone located in the room, and a computerized controller running a software application including a graphic user interface by which the audiovideo communications between the patient and the caregiver are established.

### CROSS-REFERENCE TO RELATED APPLICATION

The present application is a U.S. Nonprovisional Patent Application of, and claims priority under 35 U.S.C. § 119(e) to, U.S. Provisional Patent Application 61/052,243, filed May 11, 2008, which provisional patent application is incorporated by reference herein. The disclosure of this provisional application is contained in Appendix A, attached hereto, forming a part hereof, and incorporated herein by reference. Additionally, the following are hereby incorporated herein by reference: U.S. Patent Application Publications 2007/0188612 and 2007/0103541; and U.S. Pat. No. 7,193,644.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND

The present invention generally relates to systems and methods for providing real-time communication and monitoring of patients by a caregiver using a wireless handheld device.

It is believed that a need exists for improved accessibility of caregivers by patients. It is further believed that a need exists for improved accessibility of patients by caregivers, whereby caregivers may more readily and efficiently check-in on patients. One or more preferred embodiments of the present invention address such need.

### SUMMARY OF THE INVENTION

The present invention includes many aspects and features. Furthermore, while the present invention is described in the context of healthcare, it will be appreciated that the invention is further applicable in other contexts as well.

A first aspect of the invention relates to a method for two-way audiovideo communications between a patient in a room and a remotely located caregiver, whereby real time audiovideo communications between the patient and the remotely located caregiver is provided by the caregiver using a wireless handheld device.

The method includes the steps of: (a) transmitting, to the wireless handheld device used by the caregiver, video of the patient recorded using a camera located in the room; (b) transmitting, to the wireless handheld device used by the caregiver, audio of the patient recorded using a microphone located in the room; and (c) transmitting, to a speaker located in the room for playing to the patient, audio of the caregiver recorded using the wireless handheld device.

In accordance with this aspect, the transmitting steps include wireless communications between the camera and microphone located in the room and a computerized controller running a software application including a graphic user interface by which the audiovideo communications between the patient and the caregiver are established.

In a feature of this aspect, the audiovideo communications are streamed.

In a feature of this aspect, the wireless handheld device comprises a cell phone, a video phone, a personal digital assistant, or a smartphone.

In a feature of this aspect, the wireless handheld comprises a programmable handheld device.

In a feature of this aspect, the method further includes the step of saving a recording of the two-way audio-communications in a database for later playback.

In a feature of this aspect, the method further includes transmitting, to a display screen located in the room for presentation to the patient, video of the caregiver recorded using the wireless handheld device. Said transmitting steps may include communications over the Internet, communications over a cellular network, communications over a satellite network, or any combinations of the foregoing.

In a feature of this aspect, the method further includes remotely actuating the camera located in the room using the wireless handheld device. Said step of remotely actuating the camera may include zooming an image of the patient or a readout of a medical device in the room of the patient, and said step of remotely actuating the camera may include remotely moving the camera to change the field of view of the camera.

In a feature of this aspect, the software maintains an association of each one of a plurality of peripheral devices with respective caregivers, any of the peripheral devices capable of being utilized in the system. Furthermore, the software may provide a graphical user interface through which the audiovideo data from the wireless device is accessed by each respective caregiver using one of the peripheral devices.

In mutually exclusive features of this aspect, the room is a room of a private residence; the room is located within a hospital; the room is located within an assisted living facility; or the room is located within a nursing home.

Another aspect of the invention relates to a communications and monitoring system. The system includes: (a) a wireless device associated with a room and configured to communicate audio and video data; (b) a plurality of peripheral devices, each peripheral device associated with a respective caregiver; and (c) a computer configured for communication with the wireless device and configured for communication with each of the peripheral devices. In accordance with this aspect, the computer executes software, in accordance with which, (i) the association of each of the peripheral devices with a respective caregiver is maintained, (ii) audio and video data from the wireless device is received by the computer, and (iii) a graphical user interface is provided through which audio and video data from the wireless device is accessible by each respective caregiver using one of the peripheral devices.

In mutually exclusive features of this aspect, the room is a room of a private residence; the room is located within a hospital; the room is located within an assisted living facility; or the room is located within a nursing home.

In a feature of this aspect, the wireless device includes a camera, a microphone, a speaker, an RF transmitter, and an RF receiver.

In a feature of this aspect, the wireless device further communicates with a medical monitor located in the room.

In a feature of this aspect, audio and video data received from the wireless device is recorded, and access to the recorded audio and video data is provided through the graphical user interface, all in accordance with the software.

In a feature of this aspect, the audio and video data is recorded to a storage device selected from the group of a CD-ROM RAW, a DVD R/W, flash memory, a tape drive, a memory card, and a hard drive.

In a feature of this aspect, the computer associates one of various levels of access privileges to each caregiver, all in accordance with the software.

In another feature of this aspect, the computer contacts a particular one of the caregivers by sending a communication to the respective peripheral device associated with that caregiver based on the communications of the wireless device with a medical monitor, all in accordance with the software.

In a feature of this aspect, the computer facilitates audio communications between a patient using the wireless device, and a particular one of the caregivers, by initiating communications with the respective peripheral device associated with that caregiver, all in accordance with the software.

In a feature of this aspect, the computer is configured for communication, via the Internet, with one or more of the plurality of peripheral devices such that audio and video data from the wireless device is remotely accessible via the Internet by a respective caregiver using one of the peripheral devices.

In a feature of this aspect, the computer is configured for communication, via a public switching telephone network, with one or more of the plurality of peripheral devices such that audio and video data from the wireless device is remotely accessible via the public switching telephone by a respective caregiver using one of the peripheral devices.

In a feature of this aspect, the computer is configured for communication, via a local area network, both with the wireless device and with one or more of the plurality of peripheral devices such that audio and video data from the wireless device is accessible via the local area network by a respective caregiver using one of the peripheral devices.

In a feature of this aspect, the plurality of peripheral devices each comprises a digital communication device.

In a feature of this aspect, at least one of the plurality of peripheral devices comprises a cell phone, telephone, video-cell phone, computer, personal digital assistant, video-personal digital assistant, satellite telephone, or pager.

In a feature of this aspect, the wireless device and at least one of the peripheral devices are configured for communications via text messaging.

In a feature of this aspect, the wireless device is portable, has a locking mechanism, and an electrical receptacle for quickly attaching to a source of electricity, and wherein the wireless device further includes a portable energy source.

In a feature of this aspect, the computer comprises a module for authenticating a caregiver based on a biometric of the caregiver.

In a feature of this aspect, the biometric comprises at least one of the group of an caregiver's face, eye, voice, fingerprint, palmprint, or some other biological information.

In a feature of this aspect, the computer comprises a voice-generation apparatus.

In another aspect of the invention, a communications and monitoring system includes: (a) a wireless device associated with a room and configured to communicate audio and video data; (b) a plurality of peripheral devices, each peripheral device associated with a respective caregiver; and (c) a computer configured for communication with the wireless device and configured for communication, via the Internet, with each of the peripheral devices. In accordance with this aspect, the computer executes software, in accordance with which, (i) the association of each of the peripheral devices with a respective caregiver is maintained, (ii) audio and video data from the wireless device is received and stored by the computer, (iii) a graphical user interface is provided through which audio and video data from the wireless device is accessible, via the Internet, by each respective caregiver using one of the peripheral devices, and (iv) each caregiver is authenticated based on a biometric of the caregiver. Furthermore, in accordance with this aspect, the room is a room of a commercial or residential space that is for rent or sale.

In a feature of this aspect, communications provided are real-time communications. In another feature, communications provided are prerecorded. In other features, some communications are real-time and others are prerecorded.

In a feature of this aspect, the wireless device used by the caregiver for real time communications is a general handheld device configured, inter alia, for use with a system in accordance with this aspect. In another feature, the wireless device used by the caregiver for real time communications is a dedicated device for use solely with a system in accordance with this aspect.

In addition to the aforementioned aspects and features of the present invention, it should be noted that the present invention further encompasses the various possible combinations and subcombinations of such aspects and features.

### BRIEF DESCRIPTION OF THE DRAWINGS

FIG. 1 illustrates part of a floor plan showing patient rooms in a hospital.

FIG. 2 illustrates a system architecture in preferred systems and methods in accordance with the present invention.

FIG. 3 illustrates another system architecture in preferred systems and methods in accordance with the present invention.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

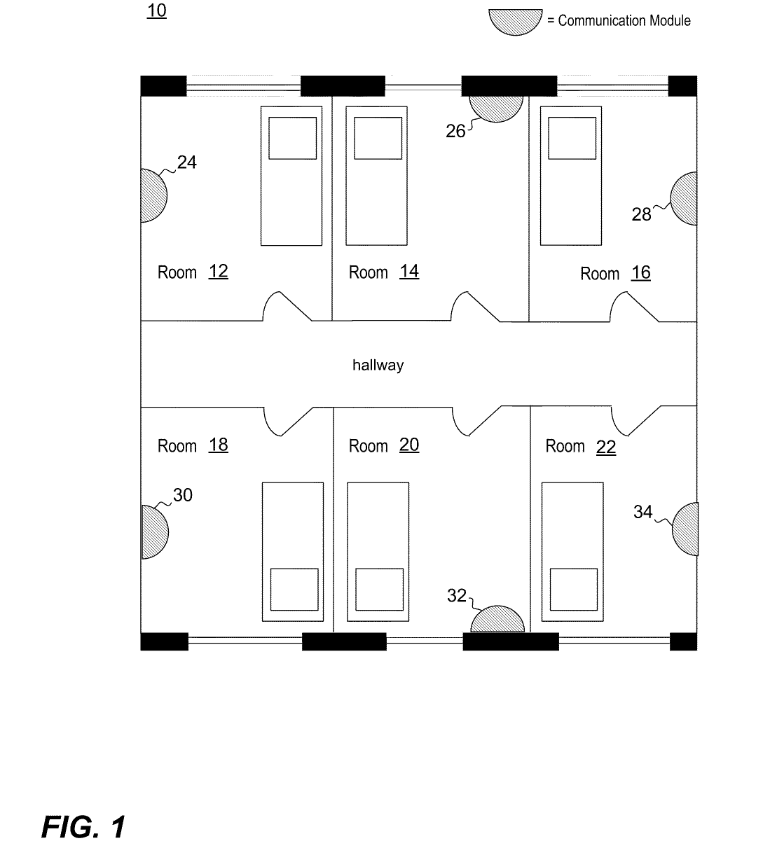

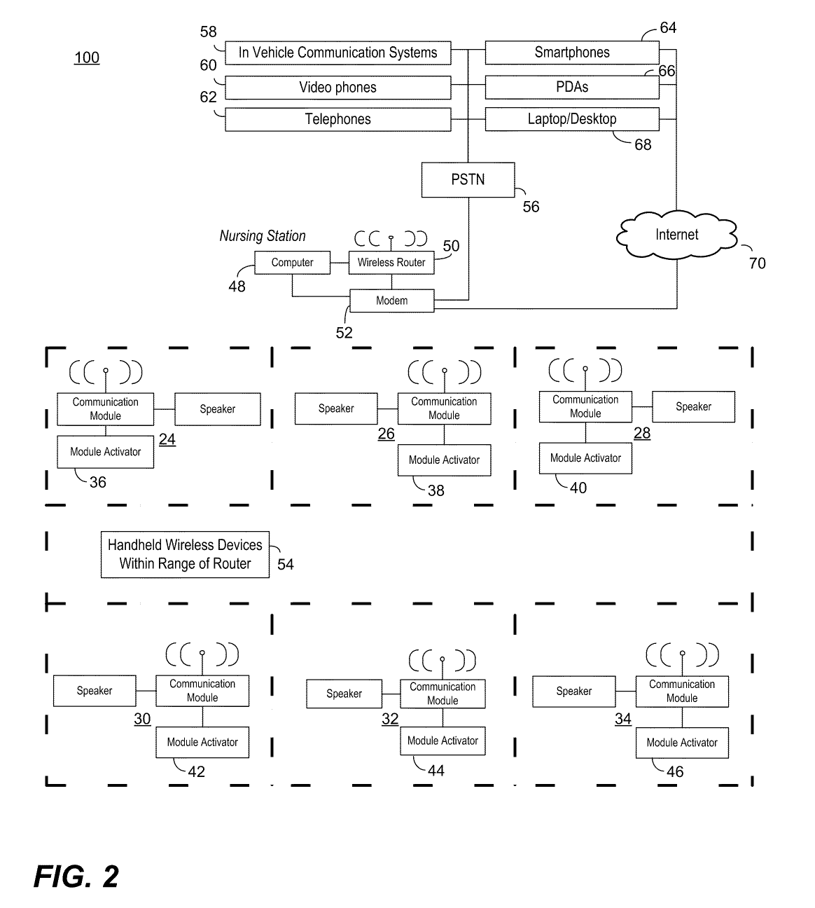

A first, preferred system 100 is now described with reference to FIGS. 1-2.

In this respect, FIG. 1 illustrates part of a floor plan showing patient rooms in a hospital. The floor plan includes a first patient room 12, a second patient room 14, a third patient room 16, a fourth patient room 18, a fifth patient room 20, and a sixth patient room 22.

In accordance with the present invention, communication modules are located in each of the patient rooms of the hospital. Specifically, these communication modules include: communication module 24 in patient room 12; communication module 26 in patient room 14; communication module 28 in patient room 16; communication module 30 in the patient room 18; communication module 32 in the patient room 20; and communication module 34 in the patient room 22.

Each communication module preferably is mounted to a wall of the room, and the communication modules are strategically placed in the rooms to provide effective communication with patients in the beds as well as to provide good fields of view of the rooms, including any medical monitors or other equipment that may be in the rooms.

Each communication module further may be portable and may be removably attached to a mounting that is secured to a wall. In this respect, the communication module or the mounting may further include a locking mechanism for securing the communication module when retained by the mounting. Each communication module also may be powered by electrical receptacle, may include a portable energy source such as a batter (especially if portable), or may include both.

FIG. 2 illustrates components of the system 100 including the communication modules arranged in on the hospital floor as shown in FIG. 1. The components shown include hardware and software components, and it will be appreciated that any hardware component of the system 100 is subject to possible replacement with a software component, and vice-versa, as desired and if within the skill of the Ordinary Artisan. Moreover, it is noted that software components have the added advantage over hardware components of being updated periodically with enhancements, and may even be reconfigured as necessary. Indeed, a software-driven system may be updated, modified, and customized for providing robust applications.

The components of the system 100 include: communication modules 24,26,28,30,32,34; module activators 36,38,40,42,44,46; a desktop or laptop computer 48 including software and data storage for implementing the invention; a wireless router 50; a modem 52; a plurality of handheld devices 54 configured for wireless communication with the wireless router 50; a plurality of telecommunication devices for communication over a public switched telephone network 56 directly with the computer 48 via the modem 52 (e.g., a telephone-line modem), such telecommunication devices including in-vehicle communication systems 58, video phones 60, telephones 62, smartphones 64, PDA devices 66 having telecommunication capabilities, and laptop and desktop computers 68 having telecommunication capabilities; and a plurality of devices for communications over the Internet 70 with the computer 48 via the modem 52 (e.g., DSL or cable modem), such devices including smartphones 72 that are web-enabled, PDA devices 74 that are web-enabled, and laptop and desktop computers 76 that are web-enabled. Optionally, the wireless router 50 may be replaced with, or function as, a wireless access point, with the computer 48 providing functions that would otherwise be provided by the wireless router 50.

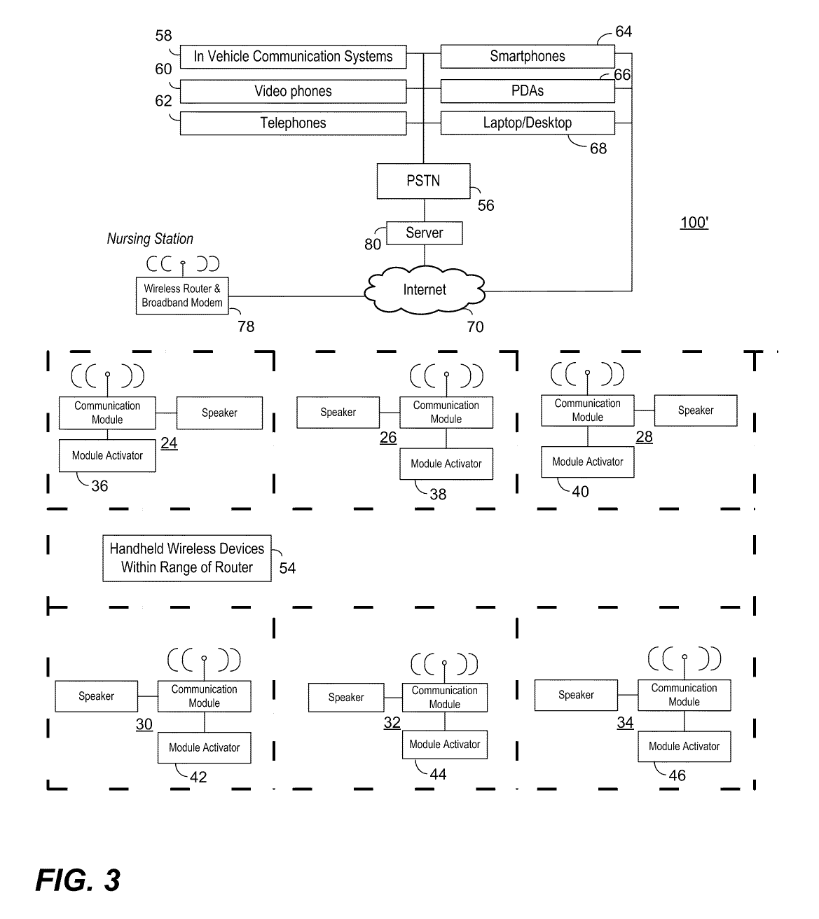

Each of the communication modules preferably includes a video camera, a microphone, a speaker, a display screen such as an LCD screen, an RF transmitter, and an RF receiver. The RF transmitter and RF receiver may be combined in the form of a radio component. The communications enabled by each communication module preferably include both audio and visual communications, although communications by only audio or video is contemplated and enabled in the system 100. Furthermore, the speaker of each communication module is shown as a separate, physical component connected to a respective communication module in FIGS. 2-3; however, it will be appreciated that the speaker component (or any other components) may be separately provided or may be integral with the respective communication module and not separate therefrom, as desired.

Each communication module also may include a proximity sensor for detecting movement of patient, and an audio sensor for detecting auditory alerts. Each communication module also may include a handheld device for use by the patient when conversing with a caregiver using the system 100. Such handheld device may be wired or wireless.

Each communication module further includes a module activator that allows a person to manually activate the communication module. The module activator also may be integral with the communication module or may be a separate device located apart from the communication module, as shown in FIGS. 2-3, but nonetheless the module activator is arranged in electronic communication with the communication module whereby the module activator may activate the communication module. Such electronic communication may be wired or wireless.

Each communication module also may be configured to communicate with a medical monitor in the room for data exchange therebetween. In this respect, upon the detection of a predetermined condition by the medical monitor, the communication module may be configured to initiate recording of images by the video camera and recording of audio by the microphone. Additionally, or alternatively, upon such detection the communication module may be configured to output a preprogrammed message or to initiate a call to one or more caregivers, including initiating an alert regarding a medical condition of the patient in the room.

Each communications module also may be configured to present a preprogrammed audiovisual message, such as a specific reminder message (such as a reminder to take medicine at a certain time); and may be configured to present a general announcement (such as a public hospital announcement for all patients).

Each of the handheld wireless devices carried by the caregivers preferably comprises a general handheld wireless device or a dedicated handheld wireless device that includes a camera, a microphone, a speaker, a display screen such as an LCD screen, an RF transmitter, and an RF receiver. The RF transmitter and RF receiver may be combined in the form of a radio component.

Each of the handheld wireless devices also preferably includes a locator component by which the location of the handheld device may be determined for communication. The locator component may be, for example, a GPS receiver. This may prove especially useful in a healthcare facility for tracking and monitoring the location of caregivers, and when giving assignments to caregivers as such assignments can be made based on caregiver location.

Similarly, a communication module may be provided with a locator component by which the location of the handheld device may be determined for communication. The locator component may be, for example, a GPS receiver. This is especially beneficial if the communications module is used in a private residence and the caregiver is a home care nurse traveling out to visit the patient. Use of the location information provided by the communications module may facilitate the caregiver's trip.

In either event, these devices sometimes are referred to herein as peripheral devices, and a peripheral device may be a cell phone, a video phone, a personal digital assistant (PDA), or a smartphone of the caregiver that has general applicability outside of the present invention. Alternatively, the peripheral device may be a dedicated device designed and configured solely for use with the system 100. In either scenario, the handheld wireless device preferably is a programmable device for which software may be written and executed on the device, and preferably is a digital communication device.

In an alternative system 100′ shown in FIG. 3, the computer 48, wireless router 50 and modem 52 are replaced by a device 78 that includes both the wireless router and modem functionality, and a computer in the form of server 80 remotely located from the property is configured for Internet communications and communicates with the combination device 78. Furthermore, the server 80 communicates with a plurality of devices over the Internet 70 including smartphones 72 that are web-enabled, PDA devices 74 that are web-enabled, and laptop and desktop computers 76 that are web-enabled; and the server 80 communicates directly with a plurality of telecommunication devices over the public switched telephone network 56 including in-vehicle communication systems 58, video phones 60, telephones 62, smartphones 64, PDA devices 66 having telecommunication capabilities, and laptop and desktop computers 68 having telecommunication capabilities. In this case, the arrangement of components in system 100′ otherwise is the same as that in system 100 of FIG. 2.

As represented in each of FIGS. 2 and 3, the computer is configured for communication, via the Internet, with one or more of the plurality of peripheral devices such that audio and video data from the communication module (also referred to herein as a wireless device) is remotely accessible via the Internet by a respective caregiver using one of the peripheral devices; the computer is configured for communication, via a public switching telephone network, with one or more of the plurality of peripheral devices such that audio and video data from the wireless device is remotely accessible via the public switching telephone by a respective caregiver using one of the peripheral devices; and the computer is configured for communication, via a local area network, both with the wireless device and with one or more of the plurality of peripheral devices such that audio and video data from the wireless device is accessible via the local area network by a respective caregiver using one of the peripheral devices.

The communication modules also are configured to communicate directly with peripheral devices when peripheral devices are within communication range of the wireless router 50. In this respect, communications over the Internet 70 or PSTN 56 are unnecessary in the arrangement of FIG. 2, as each of the peripheral devices in transmission range of the wireless router 50 may communicate directly through the wireless router with the computer 48 in gaining access to a particular communication module. This occurs, for instance, when caregivers carrying the handheld wireless devices are on the floor of the hospital and within transmission range of the wireless router 50, located for example at the nursing station. When such peripheral devices leave the communication range of the wireless router 50, communications then preferably are achieved in the system 100 over the Internet 70 through a hotspot or over a PSTN 56 (such as by way of a cellular network). In contrast, in the arrangement of FIG. 3, communications nonetheless continue to occur over the Internet 70 even when peripheral devices are within the communication range of the wireless router 50, because the server 80 is remotely located relative to the floor.

Utilizing these components, real time, two-way audiovideo communications between a patient located in one of the rooms of the hospital and a caregiver remotely located to the hospital are accomplished.

In particular, video of the patient recorded using a camera of the communication module located in the room is transmitted to the wireless handheld device used by the caregiver; audio of the patient recorded using a microphone of the communication module located in the room is transmitted to the wireless handheld device used by the caregiver. The transmitted audiovideo content is played on the handheld device used by the caregiver. Similarly, audio of the caregiver recorded using the wireless handheld device is transmitted to and played on a speaker of the communication module located in the room for presentation to the patient; and video of the caregiver recorded using the wireless handheld device is transmitted to and displayed on a screen of the communication module located in the room for presentation to the patient. The transmissions, displaying and playing of the audiovisual content preferably is in real time, whereby the patient and caregiver are able to naturally converse.

It will be appreciated that, in using the system of the invention, a patient need not necessarily orally communicate in order to convey that patient's needs, as the video may be sufficient for a caregiver to determine the patient's needs. This is believed to be a distinct advantage over conventional call boxes with two-way intercom systems that are hung proximate patient beds. Furthermore, the module activator may be provided with means for the patient to communicate in non-oral ways, including, for example, input keys for text messaging.

In order to initiate such conversation, activation of a communication module may be accomplished manually, for example, by a patient pushing a call button or otherwise actuating a physical input of the module activator with the intent of making a call to a caregiver.

A caregiver also may activate a communication module remotely, by way of the module activator, by sending an appropriate command to the module activator using the caregiver's peripheral device. A caregiver may remotely activate a communication module in order to gain real time inspection of the patient's room, including the patient and any medical monitoring equipment or other persons who may be in the room, including zooming in on an image of the patient and moving, tilting, or panning the camera to change the field of view of the area or room in which the communication module is located. Such remote observation is believed to assist the caregiver in assessing a patient's needs.

A communication module also may be automatically activated by medical equipment with which the communication module communicates. Such medical equipment may be configured to activate the communication module upon detection of a predetermined condition or event. For example, each communication module may include a medical monitor and may be automatically activated by the medical monitor upon detection of a person whose life signs are crashing. Upon such activation, the communication module may be configured to automatically send alerts to one or more predetermined caregivers and, in particular, to the peripheral devices of those caregivers. Similarly, the communication module may be configured to automatically send an alert to the computer, with the computer being configured to automatically send alerts to one or more predetermined caregivers and, in particular, to the peripheral devices of those caregivers.

The handheld wireless device, also sometimes referred to herein as peripheral devices, each preferably is associated with a respective caregiver. The computer preferably is configured for communication with each of the peripheral devices. Specifically, the computer preferably executes software, in accordance with which the association of each of the peripheral devices with a respective caregiver is maintained; audio and video data from each communication module is received by the computer; and a graphical user interface is provided through which audio and video data from each communication module is made accessible to each respective caregiver using one of the peripheral devices. Each user (or caregiver in this context) preferably has a level of privileges that define the interactions available to such user with the computer. For example, some users preferably are administrators and have access to configuration, setup and maintenance settings, whereas some users preferably are merely participants and only have the ability to access audiovisual content recorded by the computer or transmitted by a communication module for presentation, as well as the ability to converse with a patient at a communication module.

Preferably, audio and video data transmitted by each communication module is received and recorded by the computer in a database for searching and later possible playback. The audio and video data may be recorded to a storage device selected from the group of a CD-ROM R/W, a DVD R/W, flash memory, a tape drive, and a hard drive. Access by each peripheral device to the recorded audio and video data then preferably is provided through the graphical user interface. Such access may include a handoff of communications directly between the peripheral device and a particular communication module (in which case, communications also preferably are copied to the computer for recording and archiving), or may include continued use of the computer and GUI as an intermediate agent, wherein the audiovisual content communicated between the peripheral device and the communication module is transmitted by way of the computer. This latter design is believed to be preferred where the peripheral device has limited memory or processing power, and where such peripheral device is better suited to function as a thin client, wherein the processing and memory capacity of the computer are relied upon.

Security in the system is considered important. As such, the computer preferably includes an authentication module by which users of the system are authenticated. Such authentication may include password or token authentication, biometric authentication, or both. If biometric authentication is included, then each user (i.e., caregiver) preferably provides biometric data that is stored by the computer for later authentication of such user. The biometric may be the caregiver's face, eye, voice, fingerprint, palmprint, some other biological information, or any combination of the foregoing.

The computer also preferably includes voice-generation capabilities, whereby interactive-voice-recognition features (IVR)—such as those commonly found in customer service call centers—may be provided in the system.

The system 100 or system 100′ additionally may be used to manage workflow by preparing assignments for one or more caregivers or additionally may be used for a clinician or doctor who needs to communicate with his or her staff. Furthermore, such system may be maintained in an interruption based environment, meaning that the system may be functioning and in use, but can be interrupted by another announcement or buzzer.

In summary conclusion, the computer preferably serves as the gateway by which each of the peripheral devices gains access to audiovisual content transmitted by any of the communication modules. The computer also preferably serves as a repository for audiovisual content captured or presented by each of the communication modules, and serves as a historical archive of all of the audiovideo communications that have occurred at each communication module. Furthermore, in the arrangement of FIG. 3, the computer may service a plurality of floors of patient rooms, or even a plurality of hospitals or healthcare facilities, whereby a many-to-one relationship is established between the computer (in the form of server) and the facilities serviced by such computer. Still, even in this arrangement, the server acts as the gateway by which peripheral devices gain access to audiovisual content transmitted by any of the communication modules at each of the facilities; the server acts as a repository for all of the audiovisual content captured or presented by each of the communication modules at each such facility; and the server acts as a historical archive of all of the audiovideo communications that have occurred at each communication module at each such facility.

As will be appreciated by the Ordinary Artisan, one or more preferred embodiments of the invention provide real time communications between a patient and a caregiver who is absent from the patient's room. Thus, the caregiver is and remains accessible to the patient.

It is believed that the system 100 and system 100′ each bridges a gap between acute care, emergency care and general care using components that can be integrated into a large healthcare system or into a small home healthcare system, as needed.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

For instance, whereas telecommunication and Internet communications have been identified herein, it should also be understood that satellite communications similarly may be utilized in accordance with any of the aspects or features of the invention.

What is claimed is:

1. A method for two-way audiovideo communications between a patient in a room and a remotely located caregiver, whereby real time audiovideo communications between the patient and the remotely located caregiver is provided by the caregiver using a wireless handheld device, the method comprising the steps of:
(a) transmitting, to the wireless handheld device used by the caregiver, video of the patient recorded using a camera located in the room;
(b) transmitting, to the wireless handheld device used by the caregiver, audio of the patient recorded using a microphone located in the room; and
(c) transmitting, to a speaker located in the room for playing to the patient, audio of the caregiver recorded using the wireless handheld device;
(d) wherein said transmitting steps include wireless communications between the camera and microphone located in the room and a computerized controller running a software application including a graphic user interface by which the audiovideo communications between the patient and the caregiver are established.

2. The method of claim 1, wherein the wireless handheld device comprises a cell phone, a video phone, a personal digital assistant, a smartphone, or a digital communication device.

3. The method of claim 1, further comprising the step of saving a recording of the two-way audio-communications in a database for later playback.

4. The method of claim 1, further comprising transmitting, to a display screen located in the room for presentation to the patient, video of the caregiver recorded using the wireless handheld device.

5. The method of claim 1, further comprising remotely actuating the camera located in the room using the wireless handheld device.

6. The system of claim 1, wherein the software maintains an association of each one of a plurality of peripheral devices with respective caregivers, any of the peripheral devices capable of being utilized in the system.

7. The system of claim 6, wherein the software provides a graphical user interface through which the audiovideo data from the wireless device is accessed by each respective caregiver using one of the peripheral devices.

8. The system of claim 1, wherein the room is a room of a residence that is for sale or rent, or a room of a commercial space that is for sale or lease.

9. A communications and monitoring system, comprising:
(a) a wireless device associated with a room and configured to communicate audio and video data;
(b) a plurality of peripheral devices, each peripheral device associated with a respective caregiver; and
(c) a computer configured for communication with the wireless device and configured for communication with each of the peripheral devices;
(d) wherein the computer executes software, in accordance with which,
(i) the association of each of the peripheral devices with a respective caregiver is maintained,
(ii) audio and video data from the wireless device is received by the computer, and
(iii) a graphical user interface is provided through which audio and video data from the wireless device is accessible by each respective caregiver using one of the peripheral devices; and
(e) wherein the room is a room of a patient and one or more of the users are caregivers.

10. The system of claim 9, wherein the wireless device includes a camera, a microphone, a speaker, an RF transmitter, and an RF receiver.

11. The system of claim 9, wherein the wireless device further communicates with a medical monitor located in the room for actuation of the wireless device.

12. The system of claim 9, wherein, in accordance with the software, audio and video data received from the wireless device is recorded, and access to the recorded audio and video data is provided through the graphical user interface.

13. The system of claim 9, wherein, in accordance with the software, the computer contacts a particular one of the caregivers by sending a communication to the respective peripheral device associated with that caregiver based on communications of the communication module with a medical monitor.

14. The system of claim 9, wherein the computer is configured for communication, via the Internet, with one or more of the plurality of peripheral devices such that audio and video data from the wireless device is remotely accessible via the Internet by a respective caregiver using one of the peripheral devices.

15. The system of claim 9, wherein the computer is configured for communication, via a public switching telephone network, with one or more of the plurality of peripheral devices such that audio and video data from the wireless device is remotely accessible via the public switching telephone by a respective caregiver using one of the peripheral devices.

16. The system of claim 9, wherein the computer is configured for communication, via a local area network, both with the wireless device and with one or more of the plurality of peripheral devices such that audio and video data from the wireless device is accessible via the local area network by a respective caregiver using one of the peripheral devices.

17. The system of claim 9, wherein the wireless device and at least one of the peripheral devices are configured for communications via text messaging.

18. The system of claim 9, wherein the computer comprises a module for authenticating a caregiver based on a biometric of the caregiver.

19. The system of claim 9, wherein the biometric comprises at least one of the group of an caregiver's face, eye, voice, fingerprint, or palmprint.

20. A communications and monitoring system, comprising:
(a) a wireless device associated with a room and configured to communicate audio and video data;
(b) a plurality of peripheral devices, each peripheral device associated with a respective caregiver; and
(c) a computer configured for communication with the wireless device and configured for communication, via the Internet, with each of the peripheral devices;
(d) wherein the computer executes software, in accordance with which,
(i) the association of each of the peripheral devices with a respective caregiver is maintained,
(ii) audio and video data from the wireless device is received and stored by the computer,
(iii) a graphical user interface is provided through which audio and video data from the wireless device is accessible, via the Internet, by each respective caregiver using one of the peripheral devices, and
(iv) each caregiver is authenticated based on a biometric of the caregiver; and
(e) wherein the room is a room of a patient and one or more of the users are caregivers.
